(19) United States
(12) Patent Application Publication
(10) Pub. No.: US 2020/0255048 A1
(43) Pub. Date: Aug. 13, 2020

(54) DECORATIVE PART FOR VEHICLE STEERING WHEEL

(71) Applicant: Autoliv Development AB, Vårgårda (SE)

(72) Inventors: Olivier BERTRAND, Courcôme (FR); Pascal HUGAUD, Le Mesnil Le Roi (FR); Christophe POUGUARD, Maille (FR); Blaise CATEAU, Neuville De Poitou (FR)

(73) Assignee: Autoliv Development AB, Vårgårda (SE)

(21) Appl. No.: 15/780,823

(22) PCT Filed: Dec. 8, 2016
(86) PCT No.: PCT/EP2016/080311

§ 371 Date: Jun. 1, 2018

(30) Foreign Application Priority Data
Dec. 11, 2015 (FR) 1562172

(51) Int. Cl. B62D 1/06; B62D 1/04

(52) U.S. Cl. CPC B62D 1/06; B62D 1/046

(57) ABSTRACT

A decorative vehicle steering wheel part includes a first surface and second surface. A portion of the first surface is arranged to form at least part of a visible outer surface of the steering wheel when the decorative part is mounted on the steering wheel. The second surface is arranged to be hidden when the decorative part is mounted on the steering wheel. At least a first fastening interface is arranged to receive and fasten at least a first electrical and/or electronic device on another portion of the first surface. At least a second fastening interface arranged to receive and fasten at least a second electrical and/or electronic device on a portion of the second surface.

The present invention generally relates to a decorative part intended to be mounted on a motor vehicle steering wheel. In particular, the decorative part is intended to be mounted on a vehicle steering wheel that comprises at least one electronic or electrical device on its visible or outer surface. As a result, the decorative part is at least partially covered by this electronic or electrical device.

Steering wheels are known in the prior art with electronic or electrical devices that are visible by the user. Document US2010030429 describes a steering wheel with such an electronic device on the surface of the steering wheel. However, this document does not disclose any solution for offering a steering wheel with a simple architecture, in particular in terms of the decorative parts, which include visible surface portions, and which are therefore affected by the presence of the electronic device on the surface of the steering wheel.

Document EP 1,403,167 A1 describes a steering wheel cover with a decorative lighting device.

One objective of the present invention is to resolve the aforementioned drawbacks, and in particular, first of all, to propose a simple decorative part for a vehicle steering wheel, which makes it possible to implant an electrical and/or electronic device on the surface of the steering wheel.

To that end, a first aspect of the invention relates to a decorative vehicle steering wheel part, comprising at least one wall defining:

a first surface, a portion of which is arranged to form at least part of an outer surface of the steering wheel when the decorative part is mounted on the steering wheel,

a second surface opposite the first surface and arranged to be hidden when the decorative part is mounted on the steering wheel, characterized in that the decorative part comprises:

at least a first fastening interface arranged to receive and fasten at least a first electrical and/or electronic device on another portion of the first surface,

at least a second fastening interface arranged to receive and fasten at least a second electrical and/or electronic device on a portion of the second surface. The decorative part according to the present embodiment makes it possible to simplify the general architecture of the steering wheel, because it supports the fastening interfaces of the first electrical and/or electronic device, as well as the fastening interface of the second electrical and/or electronic device. In other words, the decorative part itself serves as support for at least two electrical and/or electronic devices. Furthermore, the decorative part is arranged to support-fasten an electrical and/or electronic device on a first face (its front side), and another electrical and/or electronic device on a second face, its back side. Typically, such a decorative part is a thin shell with a large surface, and its wall is therefore arranged between the first electrical and/or electronic device and the second electrical and/or electronic device. The outer surface refers to the surface oriented toward the passenger compartment of the vehicle, as opposed to a hidden surface that would be oriented toward the structure of the steering wheel. Generally, such an outer surface is visible, but of course, the outer surface can be covered by varnish, paint, natural or synthetic leather or any other covering material, or another part of the steering wheel. In such a case, the outer surface is not directly visible by the driver, but still oriented toward the passenger compartment of the vehicle, while the second surface is hidden by the decorative part itself when it is mounted on the steering wheel.

Advantageously, the first fastening interface is arranged on the first surface, and/or the second fastening interface is arranged on the second surface.

Advantageously, the decorative part comprises at least one opening arranged to allow at least one cable to pass connecting the first electrical and/or electronic device to the second surface. Such an opening, or hole, makes it possible to pass the connecting cable directly from the outer or visible surface (the front side) toward the non-visible surface (the back side), without having to have the connecting cable run along the visible surface. The aesthetic appeal is provided, without having to provide an additional cover, for example.

Advantageously, the flap comprises at least one branch, and the opening is arranged at least partially at a branch of the flap when the decorative part is mounted on the steering wheel. In this way, the passage of the cables is made easier, without needing an additional decorative part to hide these cables.

In other words, the invention relates to a decorative vehicle steering wheel part, comprising a wall defining:

a first surface arranged to form at least part of an outer surface of the steering wheel when the decorative part is mounted on the steering wheel,

a second surface opposite the first surface and arranged to be hidden when the decorative part is mounted on the steering wheel, characterized in that the decorative part comprises:

at least one opening arranged to allow a cable to pass connecting the first surface to the second surface.

Advantageously, said other portion of the first surface is arranged to be covered by the first electrical and/or electronic device. According to this embodiment, the decorative part is arranged between the first electrical and/or electronic device and the inner structure of the steering wheel.

Advantageously, said at least one portion of the second surface is arranged to be covered by the second electrical and/or electronic device. According to this embodiment, the second electrical and/or electronic device is arranged between the decorative part and the inner structure of the steering wheel.

Advantageously, the decorative part is generally annular and arranged to cover a circumference of the steering wheel continuously.

Advantageously, the outer surface is arranged to cover a branch of the steering wheel at least partially. This embodiment simplifies the installation of different electronic devices using all of the available spaces. In other words, the decorative part covers part of the branch of the steering wheel, the first surface toward the outside, the second surface in contact with the branch and/or the inner structure of the steering wheel.

Advantageously, said at least one portion of the second surface is arranged to be covered by the second electrical and/or electronic device.

Advantageously, the decorative part comprises the first electrical and/or electronic device fastened on said other portion of the first surface.

Advantageously, said at least one first fastening interface is a fastening interface by clipping and/or heading and/or welding.

Advantageously, said at least one second fastening interface is a fastening interface by clipping and/or heading and/or welding.

Advantageously, said at least one first fastening interface is a fastening interface by clipping and/or heading and/or welding, and said at least one second fastening interface is a fastening interface by clipping and/or heading and/or welding. The decorative part is arranged between the first and second devices, which are fastened rigidly, which increases the strength of the assembly.

Advantageously, the fastening interfaces of the first device and the fastening interfaces of the second device are offset from one another. This makes it possible to further stiffen the final assembly.

Advantageously, the first and/or second electrical and/or electronic device are part of, comprise or are fastened on a rigid printed circuit. In other words, the first and/or second electrical and/or electronic device are arranged on (or comprise) a rigid substrate generally made up of insulating layers of epoxy reinforced by a web of glass fibers, covering conductive tracks and an insulating varnish.

Advantageously, the decorative part is a rigid part made from acrylonitrile butadiene styrene (ABS), polycarbonate (PC), polypropylene (PP) or a mixture of these materials. The decorative part has a thickness of 3 mm or less. Such a decorative part then forms a rigid support for the electrical and/or electronic devices. In conjunction with the fastening by clipping and/or heading of a rigid printed circuit set out above, this makes it possible ultimately to form a composite part that will have better strength, since the decorative part, the first device and the second device are secured to one another.

Advantageously, the first and/or second electrical and/or electronic device are arranged to cover at least 25% of a perimeter of the steering wheel. The invention allows reliable fastening of large electronic parts on the decorative part.

Advantageously, the decorative part is arranged to be clipped (or to fit by resilient deformation) on foam of the steering wheel. Such assembly directly on the foam allows the steering wheel to be assembled quickly.

Another aspect of the invention relates to a vehicle steering wheel comprising:

at least one decorative part according to the preceding aspect,

at least one first electrical and/or electronic device fastened on said one other portion of the first surface,

at least one second electrical and/or electronic device fastened on said portion of said second surface.

Advantageously, the vehicle steering wheel comprises a cable for connecting said at least one first electrical and/or electronic device, going from one side of the first surface to one side of the second surface, through an opening of the decorative part.

A final aspect of the invention relates to a motor vehicle including a vehicle steering wheel according to the preceding aspect.

Other features and advantages of the present invention will appear more clearly upon reading the following detailed description of one embodiment of the invention, provided solely as a non-limiting example and illustrated by the appended drawings, in which:

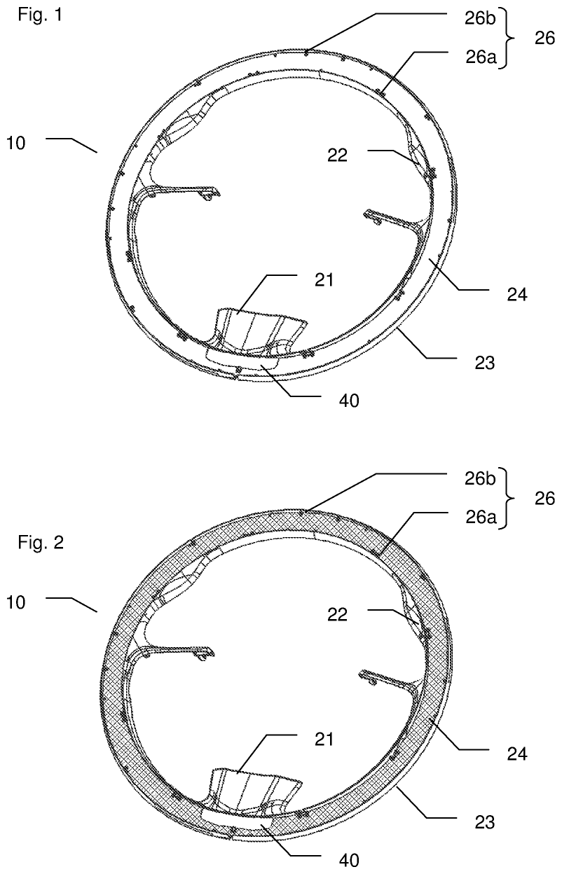

FIG. 1 shows a perspective view of the front side of a decorative part for a vehicle steering wheel, in which part of a first surface of the decorative part will be oriented toward the passenger compartment of the vehicle and/or a user, and which is arranged to receive a first electrical and/or electronic device on another portion of the first outer surface;

FIG. 2 shows the decorative part of FIG. 1, with said other portion of the first surface crosshatched;

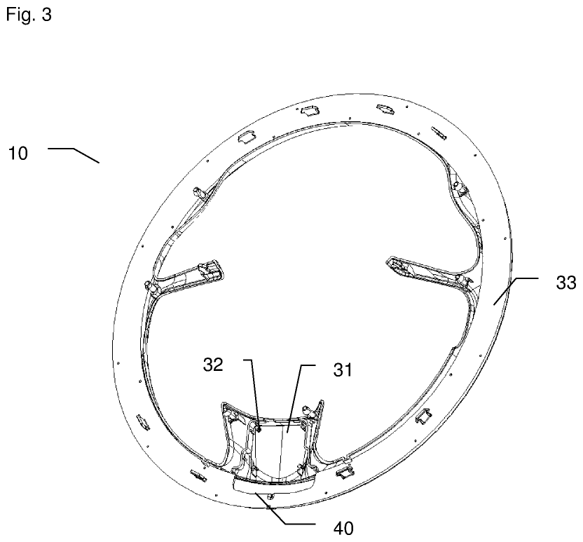

FIG. 3 shows the back side of the decorative part of FIG. 1.

FIG. 1 shows a front side of a decorative part 10 for a vehicle steering wheel (as if it was seen by a user of the vehicle, once mounted on a steering wheel). The decorative part 10 is therefore seen from above and is arranged to cover part of the rim of the steering wheel with a portion in the form of a hoop, but also a part of the branches of the steering wheel, in particular with a portion 21 oriented toward the inside of the steering wheel, or toward the shaft of the steering column.

The decorative part 10 has an upper surface that is a first surface comprising a part 23 of the first surface and a part 22 of the first surface that will be visible once the decorative part 10 is mounted on the steering wheel.

Furthermore, it is provided to place, on the surface of the steering wheel, therefore on the decorative part 10, a first electrical and/or electronic device, and the first surface then comprises another portion 24 of the first surface that will be hidden by this first electrical and/or electronic device. FIG. 2 is identical to FIG. 1 and makes it possible to view the other portion 24 of the first surface clearly, since it is crosshatched.

The first electrical and/or electronic device may for example be an illumination and/or heating device.

In general, the first electrical and/or electronic device may be provided to cover an entire circumference of the decorative part (over 360° relative to the steering column shaft). As a result in the case at hand, the other portion 24 of the first surface is a complete ring over 360° relative to the steering column shaft.

The decorative part 10 therefore covers the other portion 24 of the first surface, and the invention proposes to fasten the first electrical and/or electronic device directly on the decorative part 10. To that end, the decorative part 10 comprises a first fastening interface 26 here made up of guide ribs 26a and fastening holes 26b. Such a first fastening interface 26 can therefore be used for fastening by heading or clipping. It is also possible to provide fastening by welding (friction, ultrasound or heating). It will be understood that this embodiment avoids having to provide an interface for fastening the first electrical and/or electronic device on the steering wheel.

Furthermore, the decorative part 10 comprises an opening 40, which is a hole in its wall, in order to communicate between the upper part of the decorative part 10 (therefore visible in FIGS. 1 and 2) and the lower part of the decorative part 10 (which is visible in FIG. 3, where one sees the back side of the decorative part 10, since the latter is turned over). Such an opening 40 makes it possible to pass a connecting element such as a cable or a web of the first electrical and/or electronic device toward the lower part and the rest of the steering wheel.

This embodiment is interesting, since once the decorative part 10 is placed on the steering wheel, with the first electrical and/or electronic device above, the opening 40 is covered by the first electrical and/or electronic device, and the connecting cable can therefore pass through the opening 40 and next travel in the steering wheel, without having to provide a cover or additional trim part to hide it.

FIG. 3 therefore shows the decorative part 10 turned over, in order to view its back side, and therefore its lower surface, which is a second surface of the decorative part 10. The second surface will not be visible once the decorative part 10 is mounted on the steering wheel, and is essentially made up of a portion 33 and a portion 31. The portion 31, which is arranged to be across from the branch of the steering wheel, can form a fastening surface for a second electrical and/or electronic device, and to that end comprises a second fastening interface 32.

It is possible to consider that the second electrical and/or electronic device is a control circuit for the first electrical and/or electronic device. The second fastening interface 32 is for example a fastening interface by heading and/or clipping. The opening 40 is also visible, and for example makes it possible to connect the first electrical and/or electronic device with the second electrical and/or electronic device without the connecting element passing over an outer periphery of the decorative part 10.

As a result, the decorative part 10 according to the present invention makes it possible on the one hand to fasten, on each of its two opposite faces, an electrical and/or electronic device without modifying the inner structure of the steering wheel, since the respective fastening interfaces are directly arranged on the decorative part 10.

On the other hand, the opening arranged in the decorative part 10 makes it possible to simplify the cabling path and to avoid having to provide other covers on the steering wheel.

It will be understood that various changes and/or improvements can be made to the various embodiments of the invention described in the present description without going beyond the scope of the invention defined by the appended claims.

1. A decorative vehicle steering wheel part, comprising at least one wall defining:
a first surface, a portion of which is arranged to form at least part of an outer surface of the steering wheel when the decorative part is mounted on the steering wheel,
a second surface opposite the first surface and arranged to be hidden when the decorative part is mounted on the steering wheel,
at least a first fastening interface arranged to receive and fasten at least a first electrical and/or electronic device on another portion of the first surface,
at least a second fastening interface arranged to receive and fasten at least a second electrical and/or electronic device on a portion of the second surface.

2. The decorative part according to claim 1, further comprising, comprising at least one opening arranged to allow at least one cable to pass connecting the first electrical and/or electronic device to the second surface.

3. The decorative part according to claim 1, wherein the another portion of the first surface is arranged to be covered by the first electrical and/or electronic device.

4. The decorative part according to claim 1, having a generally annular shape and being arranged to cover a circumference of the steering wheel continuously.

5. The decorative part according to claim 1, wherein the outer surface is arranged to cover a branch of the steering wheel at least partially.

6. The decorative part according to claim 1, wherein the at least one portion of the second surface is arranged to be covered by the second electrical and/or electronic device.

7. The decorative part according to claim 1, comprising the first electrical and/or electronic device fastened on the another portion of the first surface.

8. The decorative part according to claim 1, wherein the at least one first fastening interface is a fastening interface by clipping and/or heading and/or welding.

9. The decorative part according to claim 1, wherein the at least one second fastening interface is a fastening interface by clipping and/or heading and/or welding.

10. The decorative part of claim 1, in combination with the vehicle steering wheel, wherein:
the at least one first electrical and/or electronic device is fastened on the another portion of the first surface; and
the at least one second electrical and/or electronic device is fastened on the portion of the second surface.

11. The vehicle steering wheel according to claim 10, comprising a cable for connecting the at least one first electrical and/or electronic device, going from one side of the first surface to one side of the second surface, through an opening of the decorative part.

12. The steering wheel of claim 10 in combination with a motor vehicle.
